(19) United States
(12) Patent Application Publication
(10) Pub. No.: US 2007/0012725 A1
(43) Pub. Date: Jan. 18, 2007

(54) Device and method for applying a fluid grooming product

(76) Inventor: John S. Jajeh, Fresno, CA (US)

Correspondence Address: Brian C. Leubitz, 18 Eagle St, San Francisco, CA, 94114, US

(21) Appl. No.: 11/184,510

(22) Filed: Jul. 18, 2005

(51) Int. Cl. B67D 5/52

(52) U.S. Cl. 222/137; 222/145.7; 222/145.6

(57) ABSTRACT

A method for applying a hair product and a device therefore are disclosed. Storage compartments hold fluids in one end of the device. The fluids are either mixed in a reservoir in the device or are dispensed separately, but concurrently. In one embodiment, a user can alter the comparative flow ratio between the fluids.

### FIELD OF THE INVENTION

The present invention relates generally to devices for mixing and applying liquid or cream base grooming products such as hair dye to hair and more particularly to a device and method for applying a hair product which enables a measured mixing and dispensing of the hair product.

### BACKGROUND OF THE INVENTION

Various devices and apparatus are known in the art for applying hair products. These devices conventionally include a reservoir for holding the hair product and a dispensing mechanism for dispensing the hair product onto the hair or scalp. One such device is disclosed in U.S. Pat. No. 6,672,314 entitled “Apparatus and Method for Applying a Product to Hair or Scalp”. The reservoir may include a bottle. The disclosed apparatus allows a large amount of product to be dispensed.

Commercially available hair dye kits (temporary, semi-permanent and permanent) are available and generally include two fluids that must be mixed together; a coloring agent and an activator. Gloves may be provided for this purpose. The kit may further provide an applicator for applying the mixed coloring agent and activator solution. Once mixed, the coloring agent and activator solution must be applied before it loses its efficacy. Use of such kits is an often a messy proposition.

The devices known in the prior art provide for the application of large amounts of hair products. Disadvantageously such devices do not provide an easy and convenient way of applying a small amount of hair product as in a case where a gray area such as is common among men at the temples and sideburns requires coloring. Either the devices are configured for applying large amounts of hair product or require mixing large amounts of coloring solutions.

There is therefore a need in the art for a device and method for applying a hair product that overcomes the limitations of the prior art. Such a device preferably enables a measured mixing and dispensing of the hair product. The device further preferably provides an inexpensive product which is easy to use and clean.

### SUMMARY OF THE INVENTION

In accordance with one aspect of the invention, a hair dye dispensing device is disclosed. The device comprises housing and a plurality of fluid compartments at an end of the housing. Each fluid compartment has an exit aperture. A first fluid compartment contains a hair-coloring agent. A second fluid compartment contains a hair dye-activating agent. The device further comprises a nozzle at an opposite end of the housing from the fluid compartments and a trigger on the outside of the housing.

In accordance with another aspect of the invention, a fluid dispensing device is disclosed. The fluid dispensing device comprises a plurality of fluid compartments, each fluid compartment comprising an exit aperture, wherein the exit aperture is adjustable. The device further comprises an output nozzle and a flow tube connecting each fluid compartment to the nozzle. The device also comprises a trigger on the outside of the housing, wherein depressing the trigger causes fluids to move from the fluid compartments to the nozzle.

In accordance with yet another aspect of the invention, a method of manufacturing a hair dye device is disclosed. The method comprises depositing a coloring agent in a first storage compartment and depositing an activation agent in a second storage compartment. The first storage compartment and the second storage compartment are connected to a mixing reservoir. The mixing reservoir is connected the mixing reservoir to an output nozzle.

### BRIEF DESCRIPTION OF THE DRAWINGS

The present disclosure may be better understood and its numerous features and advantages made apparent to those skilled in the art by referencing the accompanying drawings.

FIG. 1 is a first embodiment of a fluid-dispensing device.

FIG. 2 is a second embodiment of a fluid-dispensing device.

FIG. 3a is a first view of a third embodiment of a fluid-dispensing device.

FIG. 3b is a second view of a third embodiment of a fluid-dispensing device.

FIG. 3c is a third view of a third embodiment of a fluid-dispensing device.

### DETAILED DESCRIPTION OF THE INVENTION

In a first embodiment, a device for mixing multiple fluids from multiple chambers is disclosed. In a preferred embodiment, the products being mixed are hair products, more preferably hair dying fluids. The separation of the various components of hair dye allows for measured use, and reduces the need to throw away leftover amounts of hair dye chemicals. Additionally, user-definable comparative flow rates allow the user unprecedented control over the color.

Generally, two or more fluid chambers are housed at one end of the device. The fluids, such as creams, liquids, or air, can be mixed in the middle of the device in a reservoir chamber. Alternatively, the fluids may be kept separated until the application nozzle.

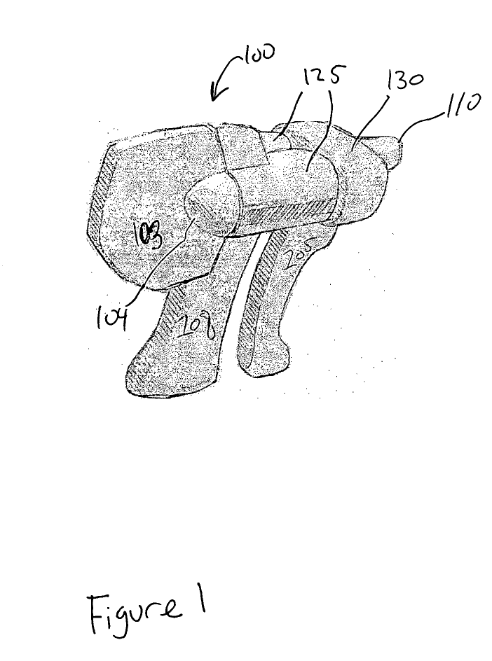

Referring now to FIG. 1, a first embodiment of a fluid mixing device 100 is seen. In this embodiment, a gun shape is used, wherein the base 103 of the gun 100 shape contains the fluid chambers 104. Only one fluid chamber 104 can be seen in FIG. 1. The base 103, or a part thereof, is preferably detachable, allowing for refillable and replaceable cartridges. The trigger 105 is preferably pulled towards the handle 108 of the gun 100 in order to eject the fluids. The fluids are pushed towards a nozzle 110 of the gun 100 when the trigger 105 is depressed. As the fluids are pushed out of the base 103 through the flow tubes 125 they can optionally pass through a reservoir 130 where the fluids are mixed. In another embodiment, the fluids are ejected separately without passing through a mixing reservoir 130. The fluids could be ejected lined up horizontally, vertically, or in other patterns when ejected directly through the nozzle 110 before being mixed.

The reservoir 130 can either simply be a chamber within the unit, or a pliable bladder can be used within the reservoir 130. In a preferred embodiment, the mixing reservoir 130 comprises a rubber bladder. To mix the fluids in the bladder reservoir, the user can shake the device or can roll the bladder with his fingers. While rubber is used in a preferred embodiment, other pliable materials, such as plastic, would also be acceptable for these purposes.

The reservoir 130 can also have an open/close switch on either side. In a preferred embodiment, the reservoir 130 has a switch that closes the reservoir 130 off from the nozzle 110. This allows mixing in the reservoir without concern of product leaking out through the nozzle. In one embodiment, a one-way door closes off the flow tubes from the reservoir, allowing fluids to flow only into the reservoir chamber from the flow tubes 125. The door would block fluids from the reservoir 130 going back into the fluid chambers 104.

The cartridges in the base 103 are preferably replaceable. This allows for different colors with one device or a replacement of the dying materials. The replaceable cartridges can be in several different sizes. This allows the manufacturer to sell low-cost small cartridges or “value” packages that contain more of the product. Additionally, the device 100 itself can also come in a variety of sizes for different purposes. For example, a device 100 intended for dyeing facial hair could be smaller than a device 100 for dyeing long hair. Furthermore other agents such as peroxide or bleach “lighteners” can be inserted to achieve different results. Additionally, the replaceable cartridges can be sealed until they are connected to the device. The fluid chambers within the replaceable cartridges are preferably sealed with a membrane. A rigid tube that connects the flow tubes 125 or reservoir 130 to the fluid chamber 104 then breaks the membrane on each fluid chamber.

In a preferred embodiment, the fluid chambers 104 are pushed towards the device in order to deposit the fluids into the device 100. The fluid chambers meet a resistance and began to empty their contents into the flow tubes 125. In one embodiment, the user pushes the base 103, which contains the fluid chambers in the replaceable cartridge, towards the device. A tightening ring can also be used to surround a fluid chamber 104. The tightening ring could then be tightened with a knob on the device causing the fluid to be released. The fluid chambers 104 can also be squeezed, like a traditional tube of toothpaste, in order to deliver their contents to the flow tubes 125. Skilled practitioners will appreciate that there are several methods of moving the product from the fluid chamber 104 to the flow tubes 125.

If a powder based product is needed, a chamber over the reservoir chamber 130 can be filled with the powder. The powder can then be combined with the liquid materials in the reservoir 130. A dial or other measurement device can be used to allow the powder to fall into the reservoir 130.

In one example, when hair dye is being applied using the present device, a coloring agent will typically be stored in one of the fluid chambers in the replaceable cartridge in the base 103. An activating agent will typically be stored in a second fluid chamber. Other fluids may be used for specific dyeing applications, if necessary. Those skilled in the art will appreciate that there are a wide variety of hair dye coloring agents and activating agents that can be used in this context.

The comparative flow rates of the fluids are either preset at the manufacturing facility, or they can be adjusted by the end user of the device. The decision of whether to allow user-defined comparative flow rates will vary upon the application of the device. In the context of hair dye products, this allows the user to select a more precise shade than was previously possible. By varying the amount of coloring agent compared to the amount of activating agent, different shades can be attained using the same bottle of coloring agent.

The skilled practitioner will understand that there are several possible ways of allowing user-selectable flow rates. In one preferred method, the user will be able to adjust the opening width of an aperture on the flow tubes 125 between the storage compartment of the refillable cartridge that resides in the base 103 and the nozzle 110. In one embodiment, the apertures are contained within the replaceable cartridge. This allows the manufacturer to determine how much control, if any, the user will have over the flow rates for each cartridge that it makes.

The output nozzle 110 can be shaped as a narrow nozzle for precise application to hair strands, or it may be a wider nozzle for faster application. In one embodiment, one of a plurality of nozzles can selectively be attached to the nozzle of the device. By making several nozzles available to users of the device, hair of all lengths and locations will be accessible.

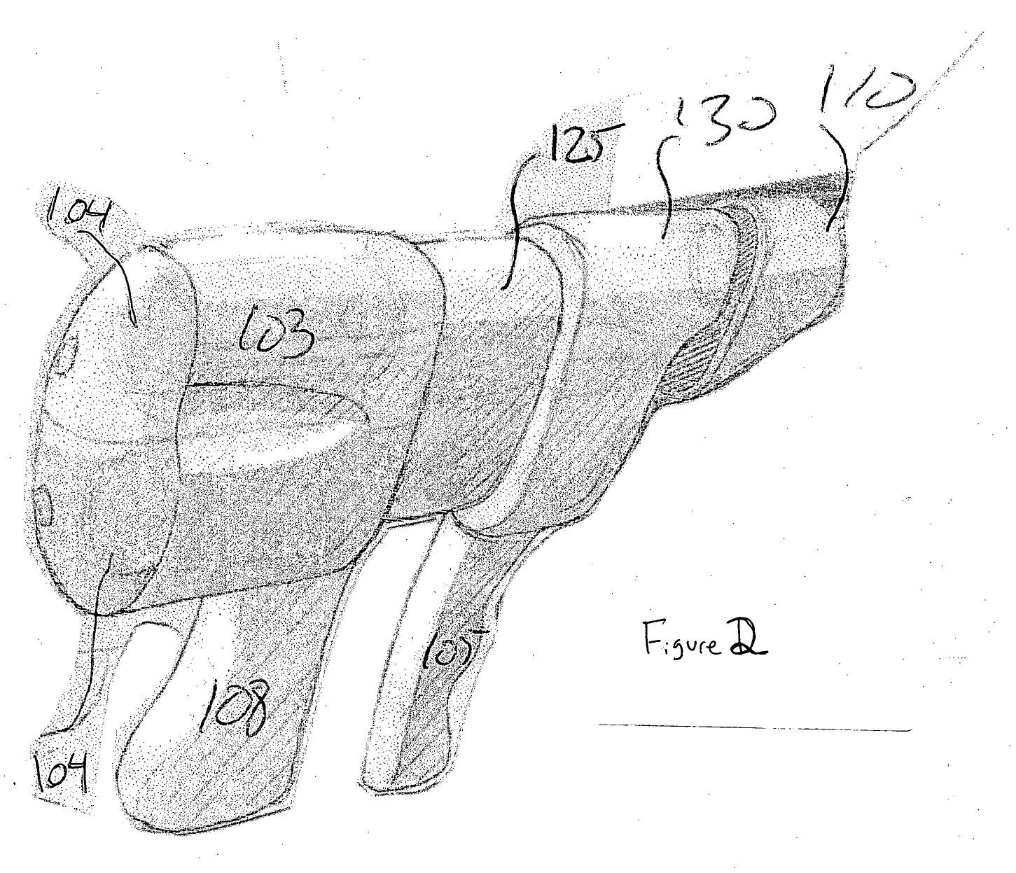

FIG. 2 illustrates a device similar to the device of FIG. 1, however, the fluid compartments 104 in the base 103 are vertically aligned rather than being side-by-side. Likewise, the flow tubes 125 are vertically aligned. Depending on the existence of a mixing reservoir 130, the nozzle 110 can also have vertically aligned exit tubes.

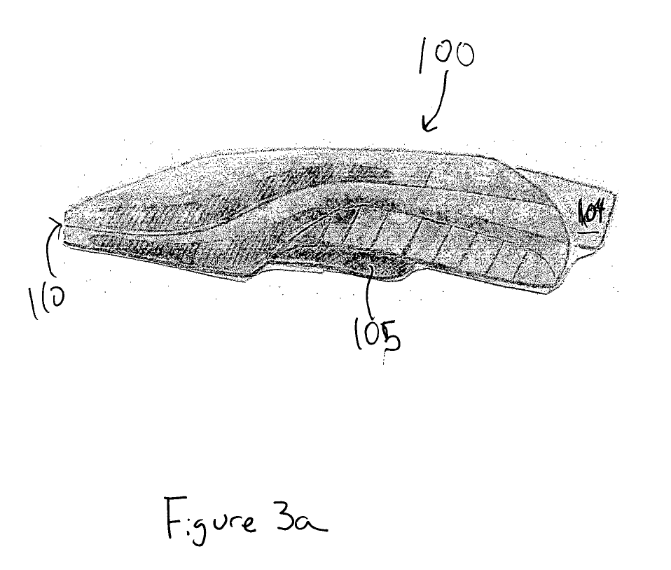

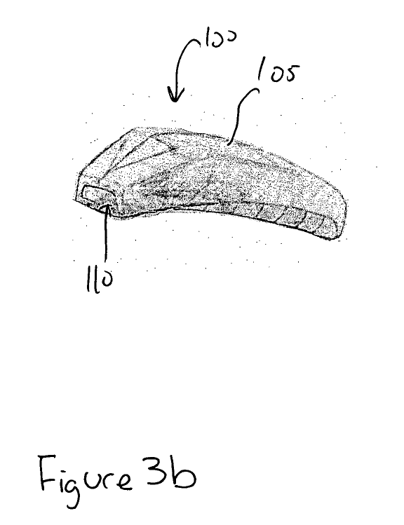

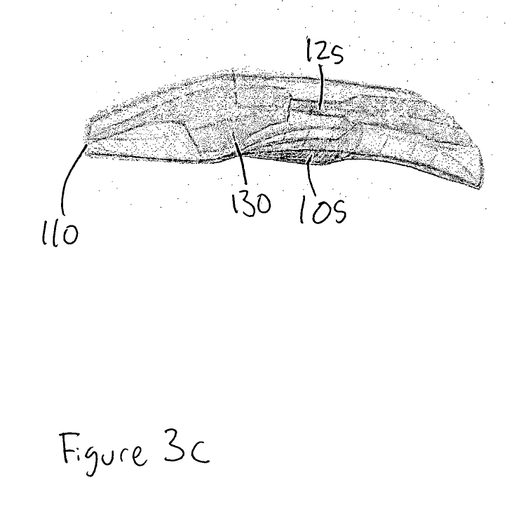

FIGS. 3a-3c illustrate another shape of the mixing and dispensing device 100. In this embodiment, the device 100 is a flatter shape, lacking the handle 108 of the previous figures. FIG. 3c shows a cross-section of the device 100 without a removable cartridge inserted. The mixing reservoir 130 and flow tubes 125 can be clearly seen. While the illustrated shapes are preferred embodiments, the device 100 is not limited to these shapes. Other possible shapes include an upright pump or a curved C-shape, amongst many others.

In a preferred embodiment, the device will be made of a material, such as plastic, that can be washed in a dishwasher. Dishwasher safe materials allow the whole device to be simply and easily washed. Also, in a preferred embodiment, the device is easily separated into two or three parts to aid in cleaning.

In one embodiment, a battery compartment is included in the device. The battery may either be a rechargeable or disposable battery. The battery allows the use of electrical indicators, electrical mixing motors, powered fluid dispensing and other powered features. Indicators, preferably on LCD screens, could tell the user how much product remains in each compartment and how much battery life remains. Additionally, the use of a battery would allow the use of an automatic mixing blade in the reservoir.

It will be understood by those of skill in the art that numerous and various modifications can be made without departing from the spirit of the present invention. Therefore, it should be clearly understood that the forms of the present invention are illustrative only and are not intended to limit the scope of the present invention.

We claim:

1. A hair dye dispensing device comprising:
a housing;
a plurality of fluid compartments at an end of the housing, each fluid compartment having an exit aperture, comprising
a first fluid compartment containing a hair coloring agent;
a second fluid compartment containing a hair dye activating agent;
a nozzle at an opposite end of the housing from the fluid compartments; and
a trigger on the outside of the housing, wherein depressing the trigger causes fluids to move from the fluid compartments to the nozzle.

2. The device of claim 1, further comprising a flow tube connecting each fluid compartment directly to the nozzle.

3. The device of claim 1, further comprising a mixing reservoir.

4. The device of claim 3, wherein the mixing reservoir comprises a pliable bladder.

5. The device of claim 1, wherein the exit apertures of the fluid housing are Adjustable.

6. The device of claim 5, wherein a width of the exit aperture is determined by a dial on the housing.

7. The device of claim 2, wherein the flow tubes have a rigid ending in order to break a membrane on the fluid compartments.

8. A fluid dispensing device comprising:
a plurality of fluid compartments, each fluid compartment comprising an exit aperture, wherein the exit aperture is adjustable;
an output nozzle;
a flow tube connecting each fluid compartment to the nozzle; and
a trigger on the outside of the housing, wherein depressing the trigger causes fluids to move from the fluid compartments to the nozzle.

9. The device of claim 8, wherein the fluid compartments are within a replaceable cartridge.

10. The device of claim 8, further comprising a battery pack.

11. The device of claim 10, further comprising an indicator screen.

12. The device of claim 11, wherein the indicator screen indicates an amount remaining in the fluid compartments.

13. The device of claim 8, further comprising a reservoir between the fluid compartments and the nozzle.

14. The device of claim 13, further comprising a mixing motor within the reservoir.

15. The device of claim 8, wherein the device consists of dishwasher safe materials.

16. The device of claim 8, further comprising an adjustable aperture to limit a flow rate from each fluid compartment.

17. The device of claim 8, wherein the plurality of fluid compartments comprise a first compartment containing a hair dye coloring agent and a second compartment containing an activating agent.

18. A method of manufacturing a hair dye device comprising:
depositing a coloring agent in a first storage compartment;
depositing an activating agent in a second storage compartment;
connecting the first storage compartment and the second storage compartment to a mixing reservoir;
providing a trigger to force the coloring agent and the activating agent into the mixing reservoir; and
connecting the mixing reservoir to an output nozzle.

19. The method of claim 18, further comprising providing an adjustable exit aperture.

20. The method of claim 18, wherein connecting the mixing reservoir to the output nozzle comprises providing a switch to prevent fluids from exiting the output nozzle.
